(19) United States
(12) Patent Application Publication
(10) Pub. No.: US 2026/0073704 A1
(43) Pub. Date: Mar. 12, 2026

(54) Object Abstraction in Smart Vehicles to Balance Vehicle Functionality with Confidentiality Preservation

(71) Applicant: International Business Machines Corporation, Armonk, NY (US)

(72) Inventors: Jun Su, Beijing (CN); Su Liu, Austin, TX (US); Zhi Li Guan, Beijing (CN); Yang Liang, Beijing (CN)

(21) Appl. No.: 18/828,278

(22) Filed: Sep. 9, 2024

(51) Int. Cl. G06V 20/58; G06V 10/34

(52) U.S. Cl. CPC G06V 20/58; G06V 10/34; G06V 2201/10

(57) ABSTRACT

Abstracting objects captured in images is provided. A plurality of relevant points is identified on each of one or more of a set of objects captured in an image of an environment needing to be abstracted. The plurality of relevant points is inserted into the image forming an abstraction of each of the one or more of the set of objects. Details in the image are masked except for the plurality of relevant points corresponding to each of the one or more of the set of objects inserted into the image to form an abstracted image of each of the one or more of the set of objects in the environment to preserve confidentiality.

### BACKGROUND

The disclosure relates generally to smart vehicles and more specifically to smart vehicle operation.

In today's digital age, the automotive industry is undergoing a shift toward smart vehicles, marking a significant evolution from traditional vehicles. This shift is not merely an enhancement, but is a fundamental transformation that positions smart vehicles at the center of mobility, safety, and environmental sustainability advancements.

For example, smart vehicles integrate sophisticated components, such as electronics, sensors, and software. These sophisticated components collaborate to collect data and autonomously adjust the smart vehicle's operations, maintenance, and comfort settings, reducing the need for human intervention. In addition, smart vehicles are connected to a larger communication ecosystem that includes, for example, Internet of Things (IoT) devices such as other vehicles, infrastructures, networks, and the like, for collecting information such as traffic congestion, weather reports, and the like in real time. Thus, smart vehicles free drivers from performing many of the tasks associated with driving, making driving a more pleasant experience.

### SUMMARY

According to one illustrative embodiment, a method is provided. A plurality of relevant points is identified on each of one or more of a set of objects captured in an image of an environment needing to be abstracted. The plurality of relevant points corresponding to each of the one or more of the set of objects is inserted into the image of the environment forming an abstraction of each of the one or more of the set of objects needing to be abstracted. Details in the image of the environment are masked except for the plurality of relevant points corresponding to each of the one or more of the set of objects inserted into the image to form an abstracted image of each of the one or more of the set of objects in the environment to preserve confidentiality. According to other illustrative embodiments, a computer system and computer program product are provided.

### BRIEF DESCRIPTION OF THE DRAWINGS

FIG. 1 is a pictorial representation of a computing environment in which illustrative embodiments may be implemented;

FIG. 2 is a diagram illustrating an example of a smart vehicle object abstraction system in accordance with an illustrative embodiment;

FIG. 3 is a diagram illustrating an example of a smart vehicle object abstraction process in accordance with an illustrative embodiment;

FIG. 4 is a diagram illustrating an example of a prediction process in accordance with an illustrative embodiment;

FIG. 5 is a diagram illustrating an example of an object detection process in accordance with an illustrative embodiment;

FIG. 6 is a diagram illustrating an example of an object relevant points identification process in accordance with an illustrative embodiment;

FIG. 7 is a diagram illustrating an example of a masking image details process in accordance with an illustrative embodiment;

FIG. 8 is a diagram illustrating an example of object metadata in accordance with an illustrative embodiment;

FIG. 9 is a diagram illustrating an example of a data structure in accordance with an illustrative embodiment; and

FIGS. 10A-10C are a flowchart illustrating a process for abstracting objects captured in images by smart vehicles to balance vehicle functionality with confidentiality preservation in accordance with an illustrative embodiment.

### DETAILED DESCRIPTION

A method identifies a plurality of relevant points on each of one or more of a set of objects captured in an image of an environment needing to be abstracted. The method inserts the plurality of relevant points corresponding to each of the one or more of the set of objects into the image of the environment forming an abstraction of each of the one or more of the set of objects needing to be abstracted. The method masks details in the image of the environment except for the plurality of relevant points corresponding to each of the one or more of the set of objects inserted into the image to form an abstracted image of each of the one or more of the set of objects in the environment to preserve confidentiality. As a result, illustrative embodiments provide a technical effect of preserving confidentiality by abstracting objects captured in images of environments.

Also, the method attaches contextual information regarding the environment as metadata to the abstracted image of each of the one or more of the set of objects in the environment. The method sends the abstracted image of each of the one or more of the set of objects in the environment with the contextual information regarding the environment attached as the metadata to a set of data analysis services. As a result, illustrative embodiments provide a technical effect of being able to send an abstracted image of each of one or more of a set of objects in an environment with contextual information regarding the environment attached as metadata to a set of data analysis services for analysis while preserving confidentiality.

In addition, the method receives information regarding analysis of the abstracted image of each of the one or more of the set of objects in the environment surrounding a smart vehicle with the contextual information regarding the environment attached as the metadata from the set of data analysis services. The method operates functional components of the smart vehicle automatically based on the information regarding the analysis of the abstracted image of each of the one or more of the set of objects in the environment surrounding the smart vehicle with the contextual information regarding the environment attached as the metadata received from the set of data analysis services. As a result, illustrative embodiments provide a technical effect of maintaining operation of functional components of a smart vehicle based on information regarding analysis of an abstracted image of each of one or more of a set of objects in an environment surrounding the smart vehicle with contextual information regarding the environment attached as metadata received from a set of data analysis services while preserving confidentiality.

Further, the method includes a prediction in the information regarding movement of each of the one or more of the set of objects in the environment surrounding the smart vehicle in relation to speed and direction of movement of the smart vehicle. As a result, illustrative embodiments provide a technical effect of providing a prediction regarding movement of each of one or more of a set of objects in an environment surrounding a smart vehicle in relation to speed and direction of movement of the smart vehicle for safety.

Furthermore, the method captures the image of the environment surrounding the smart vehicle along with contextual information regarding the environment using an Internet of Things sensor set. The contextual information includes time of day, geographic location, vehicle speed, and vehicle direction of movement of the smart vehicle. The method performs an analysis of the image of the environment surrounding the smart vehicle using computer vision and a set of machine learning models. As a result, illustrative embodiments provide a technical effect of analyzing an image of an environment surrounding a smart vehicle using computer vision and a set of machine learning models to determine whether objects are captured in the image.

Moreover, the method determines whether the image of the environment captures the set of objects based on performing an analysis of the image. The method, in response to determining that the image of the environment does capture the set of objects based on the analysis of the image, applies a set of confidentiality criteria to the set of objects captured in the image of the environment. As a result, illustrative embodiments provide a technical effect of utilizing confidentiality criteria to determine whether one or more objects captured in an image need to be abstracted to preserve confidentiality.

The method also determines whether the one or more of the set of objects captured in the image of the environment need to be abstracted based on applying a set of confidentiality criteria. The method, in response to determining that the one or more of the set of objects captured in the image of the environment do need to be abstracted based on applying the set of confidentiality criteria, identifies the plurality of relevant points on each of the one or more of the set of objects captured in the image of the environment needing to be abstracted. As a result, illustrative embodiments provide a technical effect of identifying relevant points on one or more of a set of objects captured in an image to abstract the one or more of the set of objects in the image to preserve confidentiality based on applying a set of confidentiality criteria the one or more of the set of objects in the image.

A smart vehicle system comprises a processor set, one or more computer-readable storage media, and program instructions stored on the one or more computer-readable storage media to cause the processor set to perform operations. The smart vehicle system identifies a plurality of relevant points on each of one or more of a set of objects captured in an image of an environment needing to be abstracted. The smart vehicle system inserts the plurality of relevant points corresponding to each of the one or more of the set of objects into the image of the environment forming an abstraction of each of the one or more of the set of objects needing to be abstracted. The smart vehicle system masks details in the image of the environment except for the plurality of relevant points corresponding to each of the one or more of the set of objects inserted into the image to form an abstracted image of each of the one or more of the set of objects in the environment to preserve confidentiality. As a result, illustrative embodiments provide a technical effect of preserving confidentiality by abstracting objects captured in images of environments.

Also, the smart vehicle system attaches contextual information regarding the environment as metadata to the abstracted image of each of the one or more of the set of objects in the environment. The smart vehicle system sends the abstracted image of each of the one or more of the set of objects in the environment with the contextual information regarding the environment attached as the metadata to a set of data analysis services. As a result, illustrative embodiments provide a technical effect of being able to send an abstracted image of each of one or more of a set of objects in an environment with contextual information regarding the environment attached as metadata to a set of data analysis services for analysis while preserving confidentiality.

In addition, the smart vehicle system receives information regarding analysis of the abstracted image of each of the one or more of the set of objects in the environment surrounding a smart vehicle with the contextual information regarding the environment attached as the metadata from the set of data analysis services. The information includes a prediction regarding movement of each of the one or more of the set of objects in the environment surrounding the smart vehicle in relation to speed and direction of movement of the smart vehicle. The smart vehicle system operates functional components of the smart vehicle automatically based on the information regarding the analysis of the abstracted image of each of the one or more of the set of objects in the environment surrounding the smart vehicle with the contextual information regarding the environment attached as the metadata received from the set of data analysis services. As a result, illustrative embodiments provide a technical effect of maintaining operation of functional components of a smart vehicle based on information regarding analysis of an abstracted image of each of one or more of a set of objects in an environment surrounding the smart vehicle with contextual information regarding the environment attached as metadata received from a set of data analysis services while preserving confidentiality.

Furthermore, the smart vehicle system captures the image of the environment surrounding the smart vehicle along with contextual information regarding the environment using an Internet of Things sensor set. The contextual information includes time of day, geographic location, vehicle speed, and vehicle direction of movement of the smart vehicle. The smart vehicle system performs an analysis of the image of the environment surrounding the smart vehicle using computer vision and a set of machine learning models. As a result, illustrative embodiments provide a technical effect of analyzing an image of an environment surrounding a smart vehicle using computer vision and a set of machine learning models to determine whether objects are captured in the image.

Moreover, the smart vehicle system determines whether the image of the environment captures the set of objects based on performing an analysis of the image. The smart vehicle system, in response to determining that the image of the environment does capture the set of objects based on the analysis of the image, applies a set of confidentiality criteria to the set of objects captured in the image of the environment. As a result, illustrative embodiments provide a technical effect of utilizing confidentiality criteria to determine whether one or more objects captured in an image need to be abstracted to preserve confidentiality.

The smart vehicle system also determines whether the one or more of the set of objects captured in the image of the environment need to be abstracted based on applying a set of confidentiality criteria. The smart vehicle system, in response to determining that the one or more of the set of objects captured in the image of the environment do need to be abstracted based on applying the set of confidentiality criteria, identifies the plurality of relevant points on each of the one or more of the set of objects captured in the image of the environment needing to be abstracted. As a result, illustrative embodiments provide a technical effect of identifying relevant points on one or more of a set of objects captured in an image to abstract the one or more of the set of objects in the image to preserve confidentiality based on applying a set of confidentiality criteria the one or more of the set of objects in the image.

A computer program product comprises one or more computer-readable storage media and program instructions stored on the one or more computer-readable storage media to perform operations. The computer program product identifies a plurality of relevant points on each of one or more of a set of objects captured in an image of an environment needing to be abstracted. The computer program product inserts the plurality of relevant points corresponding to each of the one or more of the set of objects into the image of the environment forming an abstraction of each of the one or more of the set of objects needing to be abstracted. The computer program product masks details in the image of the environment except for the plurality of relevant points corresponding to each of the one or more of the set of objects inserted into the image to form an abstracted image of each of the one or more of the set of objects in the environment to preserve confidentiality. As a result, illustrative embodiments provide a technical effect of preserving confidentiality by abstracting objects captured in images of environments.

Also, the computer program product attaches contextual information regarding the environment as metadata to the abstracted image of each of the one or more of the set of objects in the environment. The computer program product sends the abstracted image of each of the one or more of the set of objects in the environment with the contextual information regarding the environment attached as the metadata to a set of data analysis services. As a result, illustrative embodiments provide a technical effect of being able to send an abstracted image of each of one or more of a set of objects in an environment with contextual information regarding the environment attached as metadata to a set of data analysis services for analysis while preserving confidentiality.

In addition, the computer program product receives information regarding analysis of the abstracted image of each of the one or more of the set of objects in the environment surrounding a smart vehicle with the contextual information regarding the environment attached as the metadata from the set of data analysis services. The computer program product operates functional components of the smart vehicle automatically based on the information regarding the analysis of the abstracted image of each of the one or more of the set of objects in the environment surrounding the smart vehicle with the contextual information regarding the environment attached as the metadata received from the set of data analysis services. As a result, illustrative embodiments provide a technical effect of maintaining operation of functional components of a smart vehicle based on information regarding analysis of an abstracted image of each of one or more of a set of objects in an environment surrounding the smart vehicle with contextual information regarding the environment attached as metadata received from a set of data analysis services while preserving confidentiality.

Further, the computer program product includes a prediction in the information regarding movement of each of the one or more of the set of objects in the environment surrounding the smart vehicle in relation to speed and direction of movement of the smart vehicle. As a result, illustrative embodiments provide a technical effect of providing a prediction regarding movement of each of one or more of a set of objects in an environment surrounding a smart vehicle in relation to speed and direction of movement of the smart vehicle for safety.

Furthermore, the computer program product captures the image of the environment surrounding the smart vehicle along with contextual information regarding the environment using an Internet of Things sensor set. The contextual information includes time of day, geographic location, vehicle speed, and vehicle direction of movement of the smart vehicle. The computer program product performs an analysis of the image of the environment surrounding the smart vehicle using computer vision and a set of machine learning models. As a result, illustrative embodiments provide a technical effect of analyzing an image of an environment surrounding a smart vehicle using computer vision and a set of machine learning models to determine whether objects are captured in the image.

Moreover, the computer program product determines whether the image of the environment captures the set of objects based on performing an analysis of the image. The computer program product, in response to determining that the image of the environment does capture the set of objects based on the analysis of the image, applies a set of confidentiality criteria to the set of objects captured in the image of the environment. As a result, illustrative embodiments provide a technical effect of utilizing confidentiality criteria to determine whether one or more objects captured in an image need to be abstracted to preserve confidentiality.

The computer program product also determines whether the one or more of the set of objects captured in the image of the environment need to be abstracted based on applying a set of confidentiality criteria. The computer program product, in response to determining that the one or more of the set of objects captured in the image of the environment do need to be abstracted based on applying the set of confidentiality criteria, identifies the plurality of relevant points on each of the one or more of the set of objects captured in the image of the environment needing to be abstracted. As a result, illustrative embodiments provide a technical effect of identifying relevant points on one or more of a set of objects captured in an image to abstract the one or more of the set of objects in the image to preserve confidentiality based on applying a set of confidentiality criteria the one or more of the set of objects in the image.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

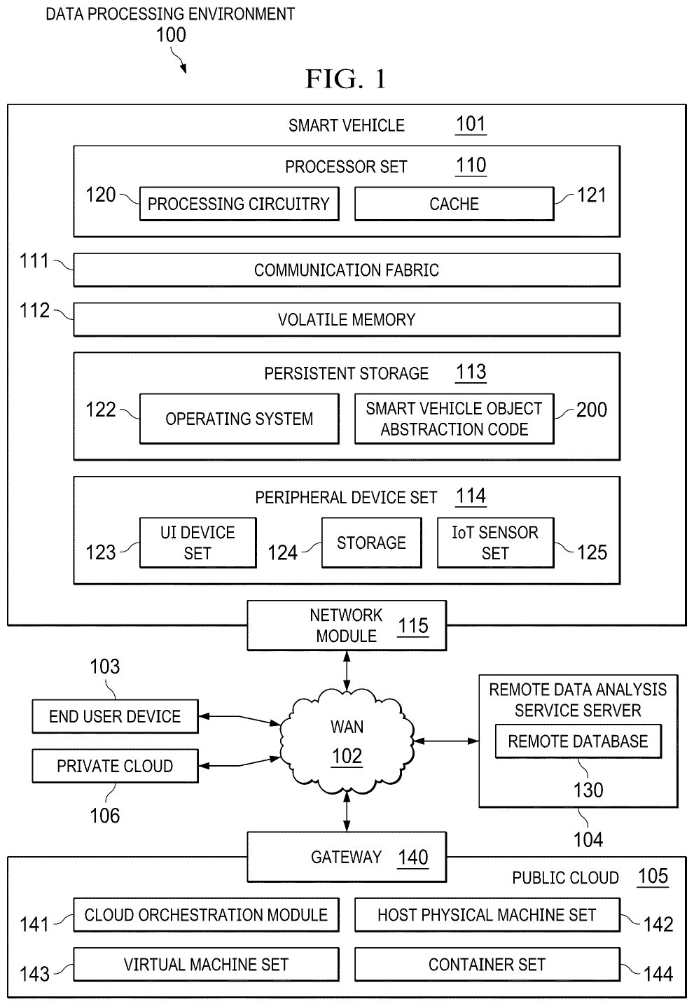

With reference now to the figures, and in particular, with reference to FIGS. 1-3, diagrams of data processing environments are provided in which illustrative embodiments may be implemented. It should be appreciated that FIGS. 1-3 are only meant as examples and are not intended to assert or imply any limitation with regard to the environments in which different embodiments may be implemented. Many modifications to the depicted environments may be made.

FIG. 1 shows a pictorial representation of a data processing environment in which illustrative embodiments may be implemented. Data processing environment 100 contains an example of an environment for the execution of at least some of the computer code involved in performing the inventive methods of illustrative embodiments, such as smart vehicle object abstraction code 200. For example, smart vehicle object abstraction code 200 balances technological advancement and confidentiality preservation in smart vehicles. In other words, smart vehicle object abstraction code 200 safeguards confidentiality while maintaining the functionality of smart vehicles. For example, smart vehicle object abstraction code 200 accesses objects' data as little as needed to protect sensitive data of objects captured in images by smart vehicles. In addition, smart vehicle object abstraction code 200 extracts only relevant points from objects. Further, by abstracting the objects captured in the images into the relevant points only, smart vehicle object abstraction code 200 preserves confidentiality and saves data bandwidth and storage space.

In addition to smart vehicle object abstraction code 200, data processing environment 100 includes, for example, smart vehicle 101, wide area network (WAN) 102, end user device (EUD) 103, remote data analysis service server 104, public cloud 105, and private cloud 106. In this embodiment, smart vehicle 101 includes processor set 110 (including processing circuitry 120 and cache 121), communication fabric 111, volatile memory 112, persistent storage 113 (including operating system 122 and smart vehicle object abstraction code 200, as identified above), peripheral device set 114 (including user interface (UI) device set 123, storage 124, and Internet of Things (IoT) sensor set 125), and network module 115. Remote data analysis service server 104 includes remote database 130. Public cloud 105 includes gateway 140, cloud orchestration module 141, host physical machine set 142, virtual machine set 143, and container set 144.

Smart vehicle 101 may take the form of any type of smart vehicle, such as, for example, a smart automobile, truck, sport utility vehicle, van, semi tractor, tractor, motorcycle, or the like, now known or to be developed in the future that is capable of, for example, running a program, accessing a network, and querying a database, such as remote database 130. As is understood in the art of smart vehicle technology, and depending upon the technology, performance of a method may be distributed among multiple smart vehicles. On the other hand, in this presentation of data processing environment 100, detailed discussion is focused on a single smart vehicle, specifically smart vehicle 101, to keep the presentation as simple as possible.

Processor set 110 includes one, or more, processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.”

Program instructions are typically loaded onto smart vehicle 101 to cause a series of operational steps to be performed by processor set 110 of smart vehicle 101 and thereby effect a method, such that the instructions thus executed will instantiate the methods specified in flowcharts and/or narrative descriptions of methods included in this document (collectively referred to as “the inventive methods”). These program instructions are stored in various types of storage media, such as cache 121 and the other storage media discussed below. The program instructions, and associated data, are accessed by processor set 110 to control and direct performance of the inventive methods. In data processing environment 100, at least some of the instructions for performing the inventive methods of illustrative embodiments may be stored in smart vehicle object abstraction code 200 in persistent storage 113.

Communication fabric 111 is the signal conduction path that allows the various components of smart vehicle 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In smart vehicle 101, the volatile memory 112 is located in a single package and is internal to smart vehicle 101.

Persistent storage 113 is any form of non-volatile storage for smart vehicle that is now known or to be developed in the future. The non-volatility of this storage means that the stored data is maintained regardless of whether power is being supplied to smart vehicle 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel.

Peripheral device set 114 includes the set of peripheral devices of smart vehicle 101. Data communication connections between the peripheral devices and the other components of smart vehicle 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as smart glasses and smart watches), keyboard, mouse, touchpad, and haptic devices. Storage 124 is external storage, such as an external hard drive, or insertable storage, such as an SD card. Storage 124 may be persistent and/or volatile. In embodiments where smart vehicle 101 is required to have a large amount of storage (e.g., where smart vehicle 101 locally stores and manages a large database) then this storage may be provided by peripheral storage devices designed for storing very large amounts of data, such as a storage area network (SAN) that is shared by multiple, geographically distributed smart vehicles. IoT sensor set 125 is made up of sensors that can be used in Internet of Things applications. For example, IoT sensor set 125 can include, for example, one or more imaging sensors, such as cameras, light detection and ranging sensors, radar sensors, ultrasonic sensors, global positioning system sensors, motion sensors, infrared sensors, velocity sensors, rain sensors, road condition sensors, and the like.

Network module 115 is the collection of software, hardware, and firmware that allows smart vehicle 101 to communicate with other smart vehicles and remote servers via WAN 102. Network module 115 may include hardware, such as Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Program instructions for performing the inventive methods can typically be downloaded to smart vehicle 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any electronic communication device that is used and controlled by an end user. For example, EUD 103 can be used by an administrator of an entity (e.g., smart vehicle manufacturer) authorized to input data and information into a service profile of smart vehicle 101. Alternatively, EUD 103 can be used by a driver of smart vehicle 101 to input driver preferences and the like in the service profile. EUD 103 may take any of a desktop computer, laptop computer, handheld computer, smart phone, virtual reality device, server computer, or the like. EUD 103 typically receives helpful and useful data from the operations of smart vehicle 101.

Remote data analysis service server 104 is any computer system that serves at least some data and/or functionality to smart vehicle 101. Remote data analysis service server 104 may be controlled and used by a service provider, decision maker, traffic administrator, and the like. Remote data analysis service server 104 can represent a plurality of machines that collect and store helpful and useful data for use by smart vehicles, such as smart vehicle 101. For example, in a hypothetical case where smart vehicle 101 is designed and programmed to generate a prediction based on historical data, then this historical data may be provided to smart vehicle 101 from remote database 130 of remote data analysis service server 104. Alternatively, remote data analysis service server 104 can provide a prediction to smart vehicle 101 based on information received from smart vehicle 101 and/or based on the historical data stored in remote database 130.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

Smart vehicles, also known as connected vehicles, intelligent vehicles, and the like, are vehicles, such as automobiles, trucks, and the like, equipped with advanced technologies that enhance safety, efficiency, and overall driving experience. These smart vehicles utilize a combination of sensors, connectivity, and artificial intelligence to interact with the surrounding environment and make informed decisions.

The sensors of a smart vehicle include, for example, imaging sensors, such as cameras, light detection and ranging sensors, radar sensors, ultrasonic sensors, global positioning system sensors, motion sensors, infrared sensors, velocity sensors, and the like. These sensors collect data from the smart vehicle's surrounding environment, which provides needed information for the safety and autonomous driving features of the smart vehicle.

The connectivity of smart vehicles enables the smart vehicles to communicate with other smart vehicles (e.g., vehicle-to-vehicle or V2V communication), with infrastructure (vehicle-to-infrastructure or V2I communication), and with the cloud. This connectivity of smart vehicles enables real-time data exchange, traffic updates, remote vehicle management, and the like.

The artificial intelligence of smart vehicles includes, for example, advanced driver assistance systems that include functionalities, such as adaptive cruise control, lane-keeping assistance, automatic emergency braking, parking assistance, and the like. These advanced driver assistance systems increase driving safety and decrease the likelihood of accidents. In addition, some smart vehicles are designed to operate autonomously, using artificial intelligence algorithms to navigate, recognize obstacles, and make driving decisions without human intervention. Also, different levels of autonomy exist, ranging from partial automation to fully autonomous smart vehicles.

Smart vehicles also include telematics systems that provide a range of services, such as remote diagnostics, vehicle tracking, entertainment, and the like. These telematics systems contribute to enhanced vehicle management and user experience.

However, smart vehicles equipped with these advanced technologies for improved vehicle safety and functionality, create concerns regarding data confidentiality and regulatory compliance. For example, as these smart vehicles collect and process large amounts of data, ensuring the confidentiality of the data and adhering to governmental regulations regarding use and dissemination of the data becomes paramount. In addition, another issue with regard to confidentiality is protecting user confidentiality. For example, the need for smart vehicles to collect and analyze data, ranging from geographic location information to driving patterns, raises confidentiality concerns among users. As a result, balancing the utility of collecting data for improving vehicle safety and functionality with safeguarding data and user confidentiality is challenging.

Furthermore, evolving data protection regulations pose challenges with regard to ensuring that smart vehicles adhere to legal frameworks. For example, compliance with regulations, such as General Data Protection Regulation, requires attention to data handling practices. Moreover, collecting more data than is needed for vehicle functionalities poses a risk to user confidentiality. Further, users may not understand the extent of the amount of data collected or the implications for the confidentiality of the users. Lack of informed user consent regarding data collection can lead to distrust and hinder the acceptance of advanced smart vehicle technologies. Thus, ensuring data collection minimization and data use limitation helps to mitigate the risks to user confidentiality.

Illustrative embodiments balance technological advancements with confidentiality preservation in smart vehicles while maintaining the functionality of smart vehicles by only collecting data needed for vehicle functionality and abstracting identified objects in collected data in real time. For example, by only collecting needed data for vehicle functionality, illustrative embodiments decrease the amount of sensitive information that is stored and transmitted, mitigating confidentiality risks and concerns. Moreover, by abstracting objects in captured images into relevant points only, illustrative embodiments save data bandwidth and storage space.

By addressing confidentiality concerns and adhering to regulatory standards, illustrative embodiments provide trustworthy smart vehicles, which increases user acceptance and ensures a balance between technological advancement and confidentiality preservation. Illustrative embodiments utilize a combination of computer vision, deep learning models, and confidentiality preserving filters to access data corresponding to objects captured in images by smart vehicles only to the degree necessary for proper functioning of the smart vehicles and for preserving the confidentiality of sensitive data corresponding to the objects captured in the images by abstracting the objects captured in the images into relevant points only without unnecessary detail being included. In other words, abstraction provides a generalized representation of an object in an image without providing details that can be used to specifically identify that particular object. Moreover, it should be noted that illustrative embodiments can also be applied to other technologies, such as, for example, closed-circuit television system, traffic monitoring systems, and the like, as needed for preserving the confidentiality of objects captured in images.

Illustrative embodiments utilize a data structure that support the operations of illustrative embodiments. The data structure includes information, such as, for example, user identifiers, vehicle identifiers, sensor identifiers, image identifiers, object identifiers, object relevant point identifiers, object relevant point image x, y coordinate identifiers, and the like.

Illustrative embodiments allow users, such as, for example, administrators and the like, to configure the smart vehicle object abstraction service. For example, illustrative embodiments allow a user to select a certain set of Internet of Things (IoT) sensors (e.g., a set of cameras) to collect data on objects detected in the environment surrounding a smart vehicle, define types of objects (e.g., humans, specific building types, vehicle license plate numbers, and the like) to abstract, and define confidentiality preserving criteria (e.g., rules for identifying the types of objects or areas having a confidentiality score greater than a defined confidentiality threshold level that need to be abstracted in images to preserve confidentiality).

Illustrative embodiments utilize the set of IoT sensors and a data collector on board the smart vehicle to collect data (e.g., images and contextual information such as time, geographic location, vehicle speed, vehicle direction of movement, and the like). In addition, illustrative embodiments can utilize V2X connectivity, which is a vehicle-to-everything communication technology that enables a vehicle to exchange data with various elements, such as other vehicles (V2V connectivity), pedestrians (V2P connectivity), infrastructure (V2I connectivity), and networks (V2N connectivity), in the environment surrounding the smart vehicle.

Illustrative embodiments also utilize an object detector to detect objects (e.g., pedestrians, animals, buildings, signs, vehicles, and the like) in images captured by the set of IoT sensors on board the smart vehicle. Illustrative embodiments utilize an object relevant point identifier to identify specific points on a set of user-specified objects captured in an image. Illustrative embodiments utilize an object relevant point extractor to extract the identified specific points on the set of user-specified objects captured in the image. Illustrative embodiments utilize a confidentiality filter to mask out or obfuscate by using, for example, blurring, pixelation, or the like of unnecessary details of confidentiality-related information, such as head features of pedestrians, license plate numbers of vehicles, sensitive buildings, secure areas, geographic location information on signs, and the like, captured in images. Illustrative embodiments utilize an image generator to construct an object relevant point image that includes, for example, the confidentiality filtered image with abstracted objects using only relevant points and metadata such as object type, confidence score, and needed contextual information.

Illustrative embodiments utilize an image and data uploader to send the object relevant point image and corresponding metadata to a set of off-board receivers (e.g., data centers, decision makers, traffic administrators, and the like) for obtaining smart vehicle data analysis services (e.g., predicting direction of movement of a detected object, such as a pedestrian, animal, autonomous robotic device, or the like, in relation to the smart vehicle's speed and direction of movement in real time). Illustrative embodiments utilize a data analysis receiver to receive information, such as predictions, recommendations, and other information, from the smart vehicle data analysis services provided by the set of off-board receivers to determine how to operate the smart vehicle safely and properly.

Thus, illustrative embodiments balance technological vehicle advancements and confidentiality preservation in smart vehicles. In other words, illustrative embodiments safeguard confidentiality while maintaining the functionality of smart vehicles by only collecting and accessing as little data, corresponding to objects in the surrounding environment of the smart vehicles, as needed in real time.

Accordingly, illustrative embodiments provide one or more technical solutions that overcome a technical problem with maintaining functionality of smart vehicles while preserving confidentiality of the data collected by the smart vehicles. As a result, these one or more technical solutions provide a technical effect and practical application in the field of smart vehicles.

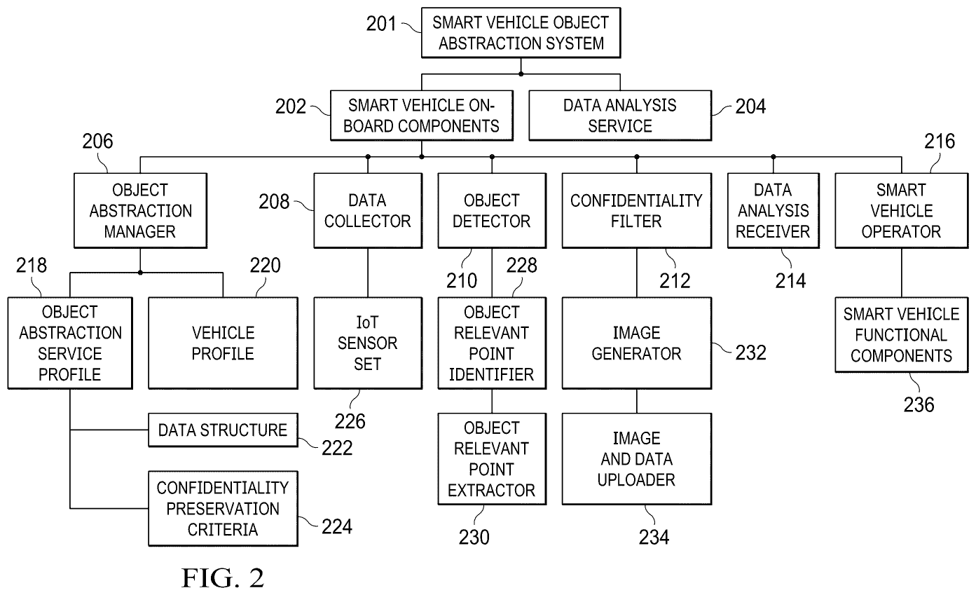

With reference now to FIG. 2, a diagram illustrating an example of a smart vehicle object abstraction system is depicted in accordance with an illustrative embodiment. Smart vehicle object abstraction system 201 can be implemented in a data processing environment, such as data processing environment 100 in FIG. 1. Smart vehicle object abstraction system 201 is a system of hardware and software components for abstracting objects captured in images by smart vehicles to balance vehicle functionality with confidentiality preservation.

In this example, smart vehicle object abstraction system 201 includes smart vehicle on-board components 202 and data analysis service 204. Smart vehicle on-board components 202 are implemented in a smart vehicle, such as smart vehicle 101 in FIG. 1. Data analysis service 204 is located in a remote server, such as remote data analysis service server 104 in FIG. 1. However, it should be noted that data analysis service 204 can represent a plurality of different data analysis services provided by a plurality of remote data analysis service servers.

In this example, smart vehicle on-board components 202 include object abstraction manager 206, data collector 208, object detector 210, confidentiality filter 212, data analysis receiver 214, and smart vehicle operator 216. Object abstraction manager 206 controls the process of automatically abstracting specific objects captured in images to preserve object confidentiality while maintaining functionality of the smart vehicle. Object abstraction manager 206 includes object abstraction service profile 218. Object abstraction service profile 218 contains data structure 222 and confidentiality preservation criteria 224. Data structure 222 contains a plurality of different types of information, such as, for example, user identifiers, vehicle identifiers, sensor identifiers, image identifiers, object identifiers, object relevant point identifiers, image coordinates identifiers for identified object relevant points, and the like, used for abstracting objects captured in images. Confidentiality preservation criteria 224 includes a plurality of rules for determining which types of objects, such as, for example, humans, road signs containing geographic location information, secure buildings, restricted areas, license plates, and the like, captured in the images are to be abstracted to preserve confidentiality. Confidentiality preservation criteria 224 can also include a defined confidentiality threshold level to determine which objects are to be abstracted in images. For example, objects having a confidentiality score greater than the defined confidentiality threshold level are abstracted in images. Object abstraction manager 206 also includes vehicle profile 220. Vehicle profile 220 contains, for example, specifications and details regarding the smart vehicle, which can be provided by the manufacturer of the smart vehicle.

Data collector 208 collects data from IoT sensor set 226. IoT sensor set 226 includes sensors, such as, for example, imaging sensors or cameras. IoT sensor set 226 captures images of the environment surrounding the smart vehicle.

Object detector 210 detects whether a set of objects are captured in an image generated by IoT sensor set 226. Object detector 210 can utilize, for example, computer vision and machine learning models, such as convolutional neural networks, recurrent neural networks, and the like, to detect the objects.

Confidentiality filter 212 applies confidentiality preservation criteria 224 to an object, which is detected by object detector 210 in an image, to determine whether the object needs to be abstracted to maintain confidentiality of that object. If confidentiality filter 212 determines that an object needs to be abstracted to maintain confidentiality of the object based on applying confidentiality preservation criteria 224, then object relevant point identifier 228 identifies a plurality of relevant points on the object, which needs to be abstracted. Then, object relevant point extractor 230 extracts the plurality of relevant points corresponding to the object that needs to be abstracted.

Image generator 232 inserts the plurality of relevant points corresponding to the object that needs to be abstracted into the image. In addition, image generator 232 masks or obfuscates unnecessary details in the image by, for example, blurring or pixelation of the details to generate an abstracted image containing the plurality of relevant points corresponding to the object. Further, image generator 232 attaches metadata, such as, for example, smart vehicle speed, smart vehicle direction of movement, type of object (e.g., pedestrian), confidence score corresponding to identification of the object, time of day when image was captured, and the like, to the abstracted image containing the plurality of relevant points corresponding to the object.

Image and data uploader 234 sends the abstracted image containing the plurality of relevant points corresponding to the object and the attached metadata to data analysis service 204. Data analysis service 204 can represent a set of data analysis services located on remote data analysis service servers, such as remote data analysis service server 104 in FIG. 1. Data analysis service 204 analyzes the abstracted image containing the plurality of relevant points corresponding to the object and the attached metadata to, for example, generate a prediction regarding movement of the object in relation to the speed and direction of movement of the smart vehicle. Data analysis service 204 can also generate recommendations and other information regarding the environment surrounding the smart vehicle based on the analysis of the abstracted image containing the plurality of relevant points corresponding to the object and the attached metadata.

Subsequently, data analysis service 204 sends the prediction, recommendations, and other information regarding the environment surrounding the smart vehicle to data analysis receiver 214 of the smart vehicle. Data analysis receiver 214 then transfers the prediction, recommendations, and other information regarding the environment surrounding the smart vehicle to smart vehicle operator 216. Based on the prediction, recommendations, and other information regarding the environment surrounding the smart vehicle received from data analysis service 204, smart vehicle operator 216 automatically operates smart vehicle functional components 236 of the smart vehicle. Smart vehicle functional components 236 include, for example, object evasion, automatic braking, lane-keeping assistance, adaptive cruise control, parking assistance, and the like.

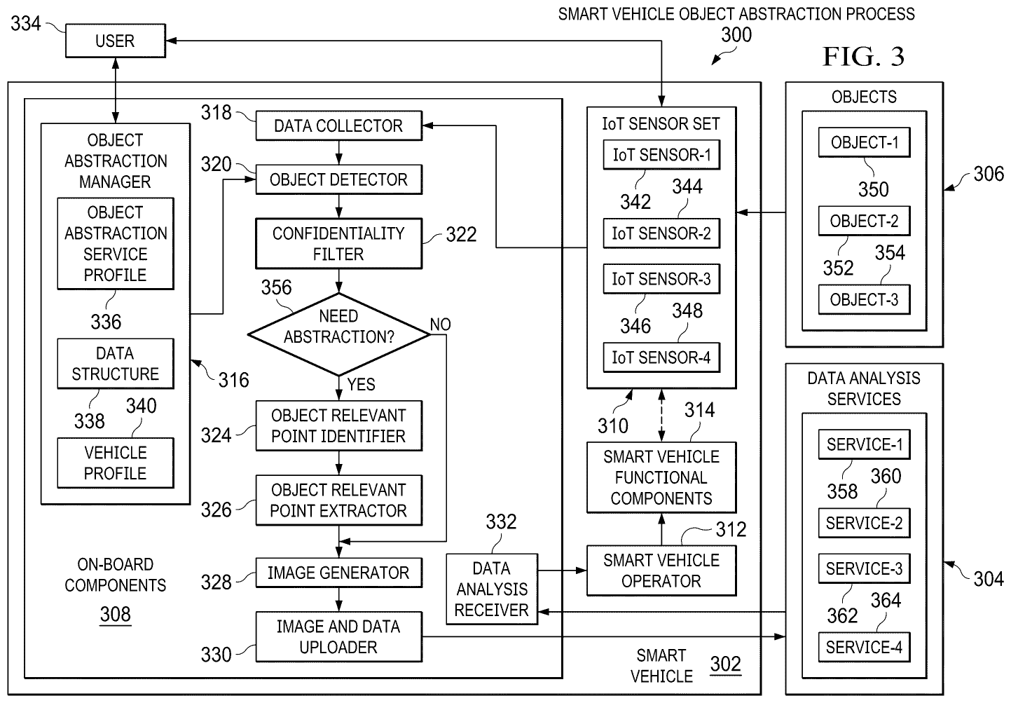

With reference now to FIG. 3, a diagram illustrating an example of a smart vehicle object abstraction process is depicted in accordance with an illustrative embodiment. Smart vehicle object abstraction process 300 can be implemented in data processing environment 100 in FIG. 1 or smart vehicle object abstraction system 201 in FIG. 2.

In this example, smart vehicle object abstraction process 300 includes smart vehicle 302, data analysis services 304, and objects 306. Smart vehicle 302 can be, for example, smart vehicle 101 in FIG. 1. Data analysis services 304 can be any type of data analysis service located on a remote data analysis service server, such as remote data analysis service server 104 in FIG. 1. Objects 306 can be any type of object, such as, for example, pedestrians, animals, signs, vehicles, bicycles, buildings, and the like.

Smart vehicle 302 includes on-board components 308, such as smart vehicle on-board components 202 in FIG. 2, IoT sensor set 310, smart vehicle operator 312, and smart vehicle functional components 314. In this example, on-board components 308 include object abstraction manager 316, data collector 318, object detector 320, confidentiality filter 322, object relevant point identifier 324, object relevant point extractor 326, image generator 328, image and data uploader 330, and data analysis receiver 332.

User 334, such as an administrator, can configure object abstraction manager 316 and select certain sensors (e.g., cameras) of IoT sensor set 310. Object abstraction manager 316 includes object abstraction service profile 336, data structure 338, and vehicle profile 340. In this example, IoT sensor set 310 includes IoT sensor-1 342, IoT sensor-2 344, IoT sensor-3 346, and IoT sensor-4 348. However, it should be noted that IoT sensor set 310 can include any number and type of sensors.

IoT sensor set 310 collects data (e.g., series of images) corresponding to objects 306. Objects 306 are located in the environment surrounding smart vehicle 302. In this example, objects 306 include object-1 350, object-2 352, and object-3 354. However, it should be noted that objects 306 can include any number and type of objects in the environment surrounding smart vehicle 302.

IoT sensor set 310 sends the collected data to data collector 318 in real time. Data collector transfers the collected data received from IoT sensor set 310 to object detector 320. Object detector 320 analyzes the collected data received from IoT sensor set 310 to identify objects 306 captured in the series of images. Confidentiality filter 322 applies a set of confidentiality preservation criteria, such as confidentiality preservation criteria 224 in FIG. 2, to the collected data to determine whether any of objects 306 need to be abstracted to preserve confidentiality.

At 356, a determination is made as to whether one or more of objects 306 need abstraction based on confidentiality filter 322 applying the set of confidentiality preservation criteria to the collected data. If objects 306 do not need abstraction, then image and data uploader 330 sends the collected data to data analysis services 304 for analysis. In this example, data analysis services 304 include service-1 358, service-2 360, service-3 362, and service-4 364. However, it should be noted that data analysis services 304 can include any number and type of data analysis services.

If one or more of objects 306 need abstraction based on confidentiality filter 322 applying the set of confidentiality preservation criteria to the collected data, then object relevant point identifier 324 identifies the relevant points of the one or more objects. Afterward, object relevant point extractor 326 extracts the identified relevant points of the one or more objects that need to be abstracted and sends the extracted relevant points of the one or more objects to image generator 328. Image generator 328 inserts the relevant points of the one or more objects into the series of images, masks or removes any unnecessary details in the series of images, and attaches any relevant contextual data to generate an abstracted series of images.

Image and data uploader 330 sends the abstracted series of images to data analysis services 304 for analysis. Based on the analysis of the abstracted series of images, data analysis services 304 sends to data analysis receiver 332 at least one of a set of predictions, a set of recommendations, and a set of information regarding objects 306, the environment surrounding smart vehicle 302, and the operation and functionality of smart vehicle 302. Data analysis receiver 332 transfers the set of predictions, recommendations, and other information regarding objects 306, the environment surrounding smart vehicle 302, and the operation of smart vehicle 302 to smart vehicle operator 312. Based on the set of predictions, recommendations, and other information regarding objects 306, the environment surrounding smart vehicle 302, and the operation of smart vehicle 302, smart vehicle operator 312 automatically controls smart vehicle functional components 314 for operating the smart vehicle safety and properly.

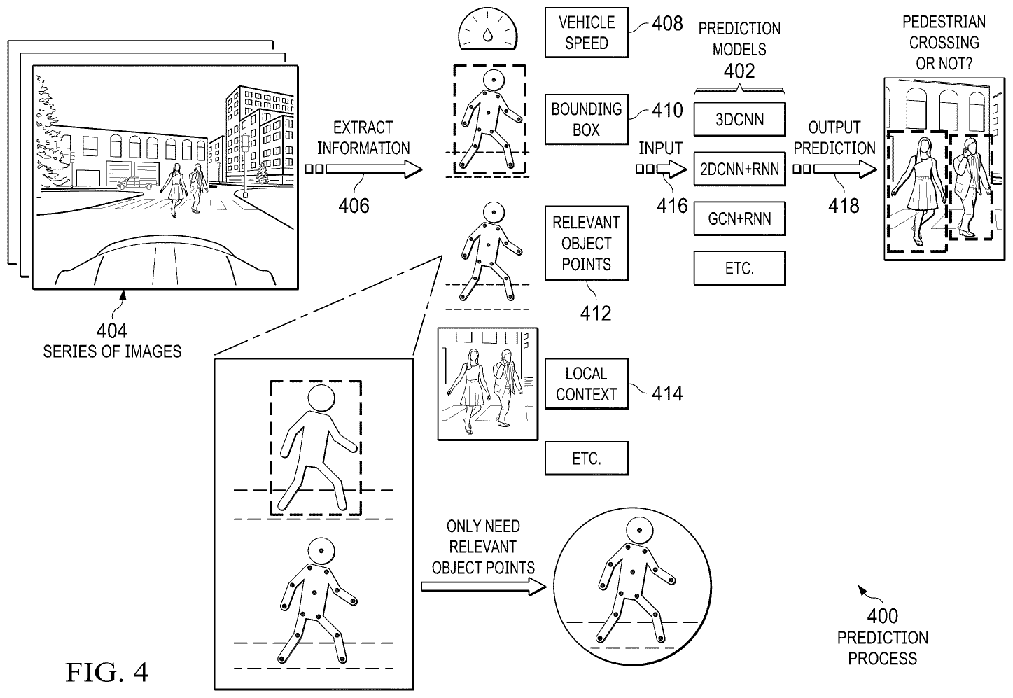

With reference now to FIG. 4, a diagram illustrating an example of a prediction process is depicted in accordance with an illustrative embodiment. Prediction process 400 can be implemented in a smart vehicle object abstraction system, such as smart vehicle object abstraction system 201 in FIG. 2.

Prediction process 400 includes prediction models 402 and series of images 404. Prediction models 402 can be, for example, machine learning models, such as convolutional neural networks, two-dimensional convolutional neural networks, three-dimensional convolutional neural networks, recurrent neural networks, graph convolutional networks, or any type of computer trained, generative artificial intelligence models, but not limited to these examples. Series of images 404 are captured by an IoT sensor set, such as IoT sensor set 310 in FIG. 3, corresponding to a smart vehicle, such as smart vehicle 302 in FIG. 3.

At 406, prediction process 400 extracts information, such as vehicle speed 408, bounding box 410, relevant object points 412, local context 414, and the like, based on analyzing series of images 404 and other data collected by the IoT sensor set. At 416, prediction process 400 inputs vehicle speed 408, bounding box 410, relevant object points 412, and local context 414 into prediction models 402. At 418, prediction models 402 output a prediction (e.g., will the pedestrian captured in series of images 404 cross in front of the smart vehicle), along with a confidence score.

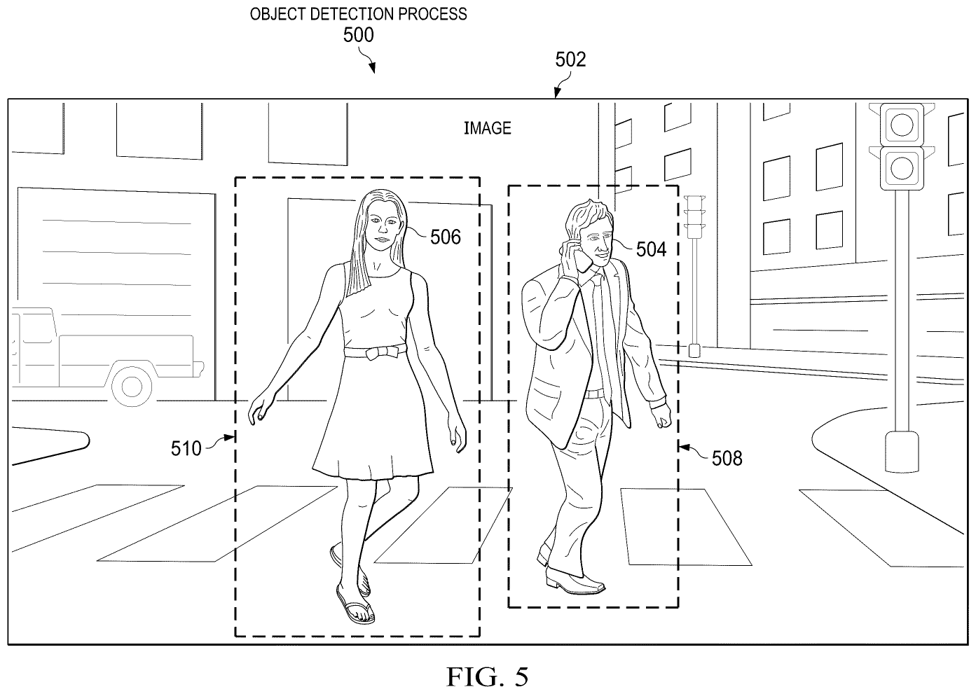

With reference now to FIG. 5, a diagram illustrating an example of an object detection process is depicted in accordance with an illustrative embodiment. Object detection process 500 can be implemented in an object detector, such as object detector 320 in FIG. 3.

In this example, object detection process 500 analyzes image 502. Upon analysis of image 502, object detection process 500 detects object 504 and object 506 in image 502. In this example, object 504 and object 506 are pedestrians in an environment surrounding a smart vehicle, such as smart vehicle 302 in FIG. 3. Object detection process 500, in response to detecting object 504 and object 506, generates bounding box 508 around object 504 and bounding box 510 around object 506. Bounding box 508 and bounding box 510 can be, for example, bounding box 410 in FIG. 4.

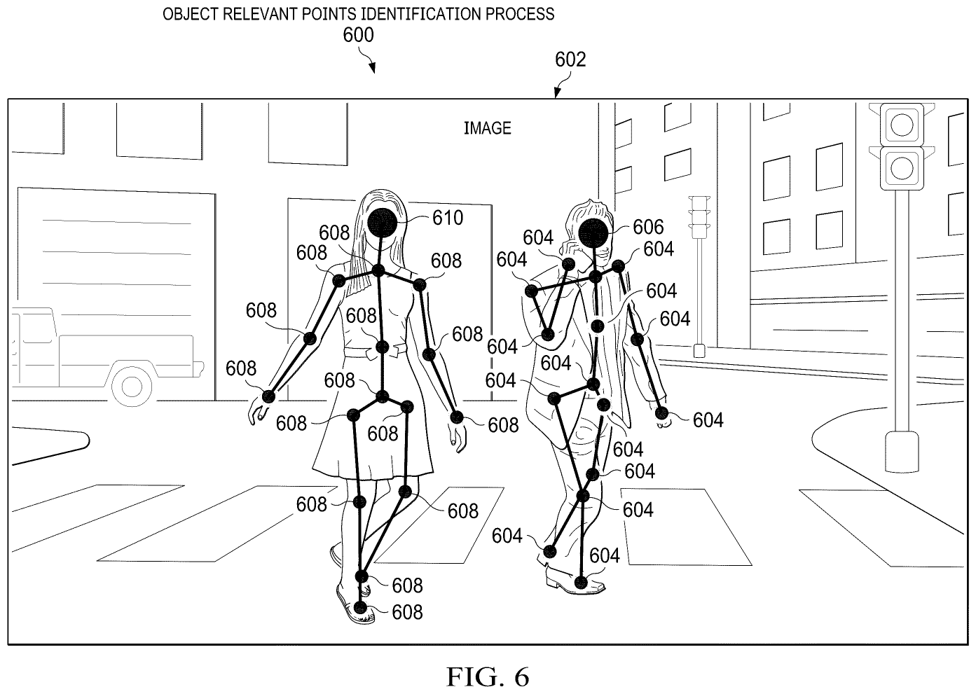

With reference now to FIG. 6, a diagram illustrating an example of an object relevant points identification process is depicted in accordance with an illustrative embodiment. Object relevant points identification process 600 can be implemented in an object relevant point identifier, such as object relevant point identifier 324 in FIG. 3.

In this example, object relevant points identification process 600 analyzes image 602. It should be noted that image 602 is the same as image 502 in FIG. 5. Object relevant points identification process 600 identifies relevant points 604 corresponding to object 606 and relevant points 608 corresponding to object 610. It should be noted that object 606 and object 610 are the same as object 504 and object 506, respectively, in FIG. 5. The identified relevant points are predefined points for the type of object detected in the image. In this example, the type of object is a human, and the predefined points include head, shoulders, elbows, wrists, hips, knees, and ankles. The predefined points for different types of objects are specified by a user (e.g., an administrator, vehicle owner, vehicle driver, pedestrian, or anyone else with certain privileges), such as user 334 in FIG. 3, in an object abstraction service profile, such as object abstraction service profile 336 in FIG. 3. As an example, a pedestrian can configure the object abstraction service profile to filter out the pedestrian from any images captured in a user-specified geographic area (e.g., New York). Similarly, a vehicle driver can configure the object abstraction service profile to filter out any family members of the vehicle driver captured in images. Relevant points 604 and relevant points 608 are for abstracting object 606 and object 610, respectively, to preserve confidentiality of object 606 and object 610.

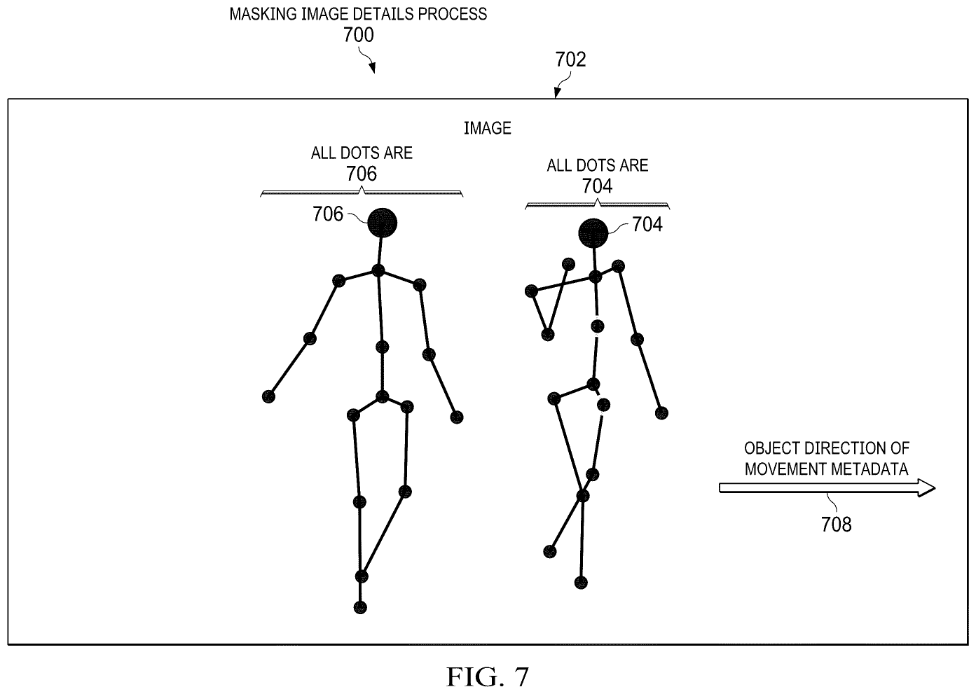

With reference now to FIG. 7, a diagram illustrating an example of a masking image details process is depicted in accordance with an illustrative embodiment. Masking image details process 700 can be implemented in an image generator, such as image generator 328 in FIG. 3.

In this example, masking image details process 700 obfuscates the details of image 702 by removing all details except relevant object points 704 and relevant object points 706 to form an abstracted image to preserve confidentiality. It should be noted that relevant object points 704 and relevant object points 706 are the same as relevant points 604 corresponding to object 606 and relevant points 608 corresponding to object 610, respectively. In addition, masking image details process 700 attaches object direction of movement metadata 708 to image 702.

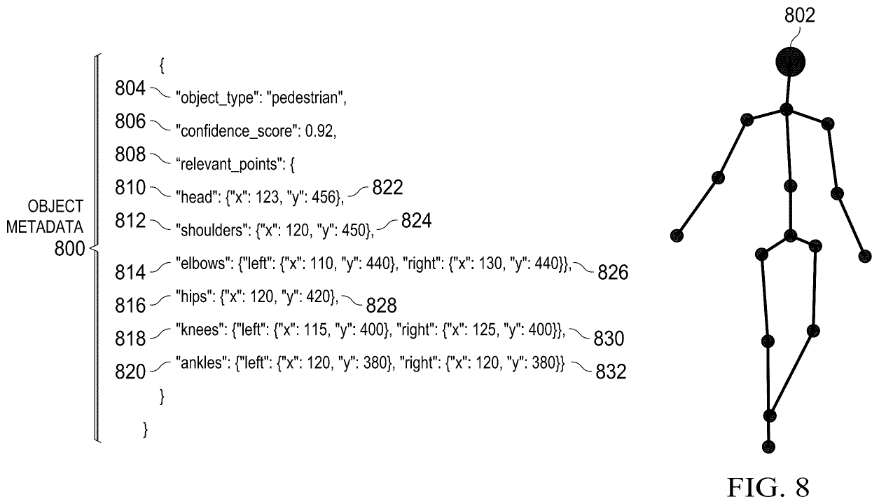

With reference now to FIG. 8, a diagram illustrating an example of object metadata is depicted in accordance with an illustrative embodiment. Object metadata 800 corresponds to object 802, which is the same as object 610 having corresponding relevant points 608 in FIG. 6.

In this example, object metadata 800 includes object type 804, confidence score 806, and relevant points 808. Object type 804 is a pedestrian in this example. Confidence score 806 is 92% that object type 804 is a pedestrian. Relevant points 808 include head 810, shoulders 812, elbows 814, hips 816, knees 818, and ankles 820. In addition, object metadata 800 also includes image x, y coordinates 822 for head 810, image x, y coordinates 824 for shoulders 812, image x, y coordinates 826 for elbows 814, image x, y coordinates 828 for hips 816, image x, y coordinates 830 for knees 818, and image x, y coordinates 832 for ankles 820.

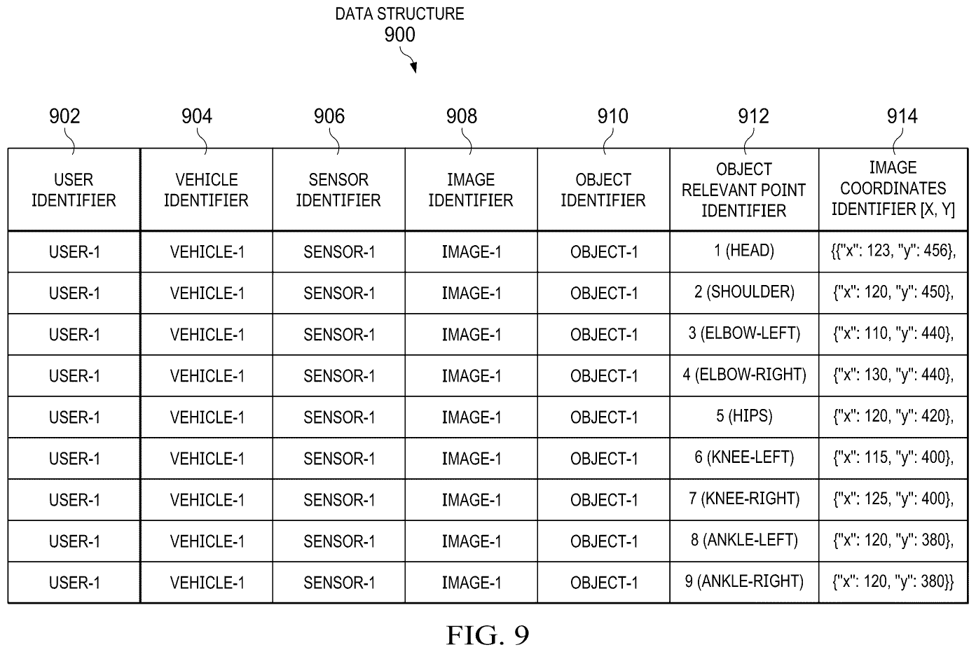

With reference now to FIG. 9, a diagram illustrating an example of a data structure is depicted in accordance with an illustrative embodiment. Data structure 900 can be implemented in an object abstraction manager, such as object abstraction manager 316 in FIG. 3. For example, data structure 900 can be data structure 338 in FIG. 3.

In this example, data structure 900 includes user identifier 902, vehicle identifier 904, sensor identifier 906, image identifier 908, object identifier 910, object relevant point identifier 912, and image coordinates identifier 914. User identifier 902 uniquely identifies the user (e.g., user-1) of a particular smart vehicle (e.g., vehicle-1) corresponding to vehicle identifier 904. Sensor identifier 906 uniquely identifies the sensor (e.g., sensor-1), which captured an image (e.g., image-1) corresponding to image identifier 908. Object identifier 910 uniquely identifies an object (e.g., object-1) captured in the image corresponding to image identifier 908. Object relevant point identifier 912 uniquely identifies the different relevant points (e.g., relevant points 808-820 in FIG. 8) on the object identified by object identifier 910. Image coordinates identifier 914 uniquely identifies the image x, y coordinates (e.g., image x, y coordinates 822-832 in FIG. 8) of the different relevant points identified by object relevant point identifier 912, which corresponds to object identifier 910.

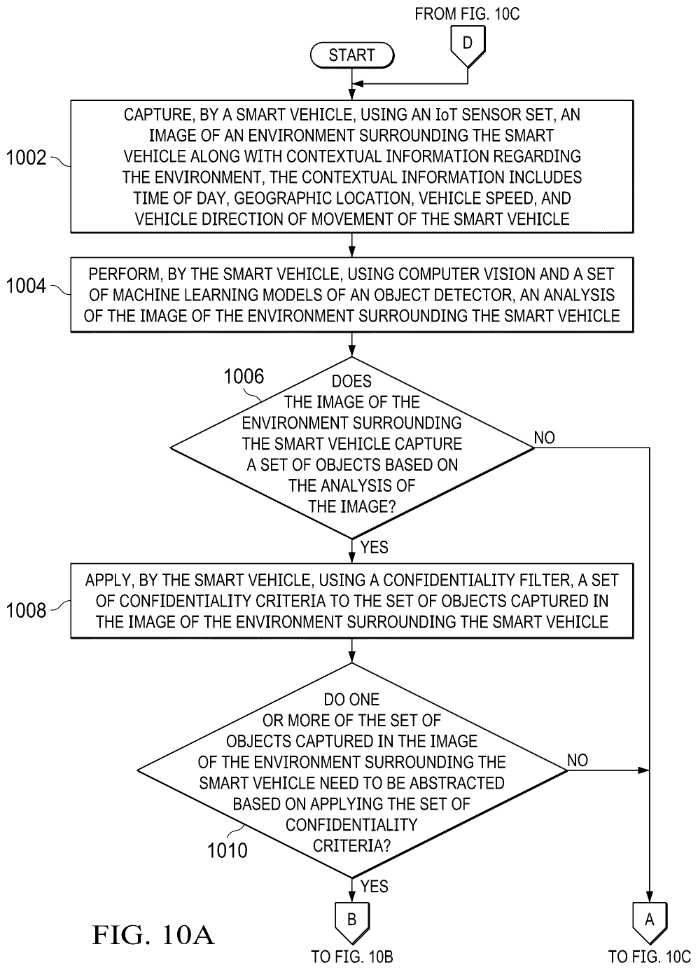

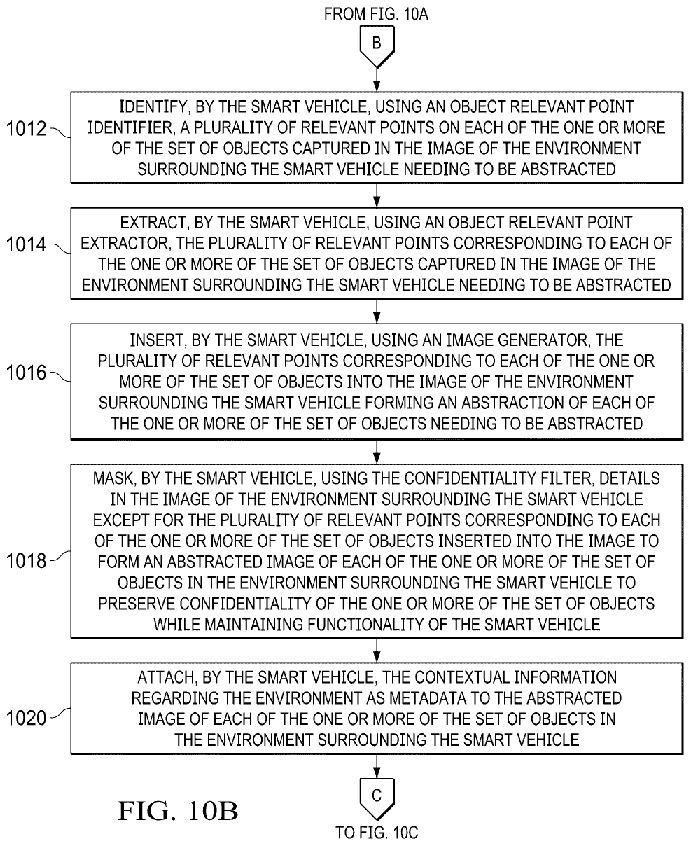

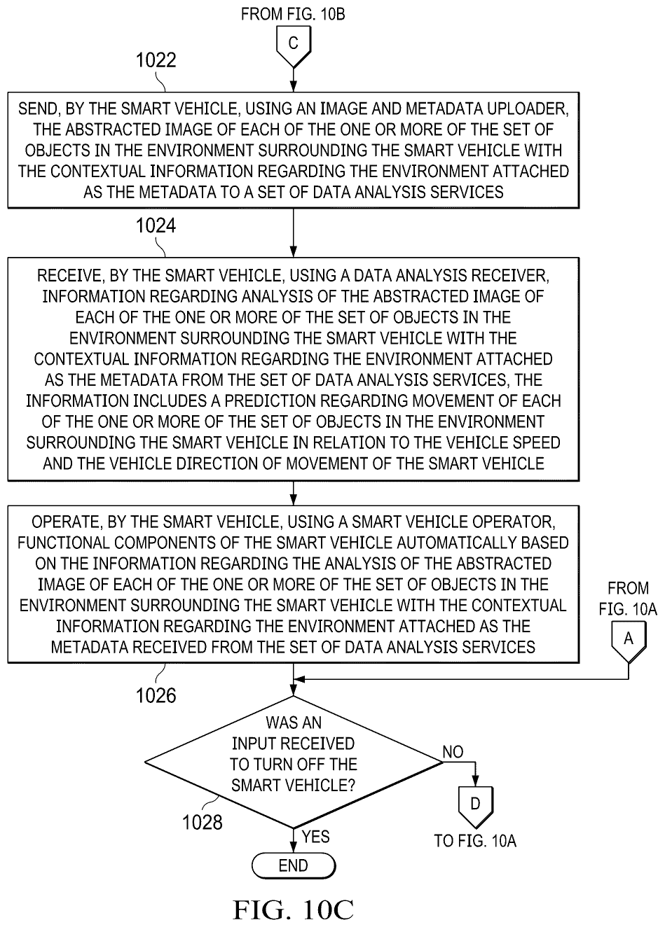

With reference now to FIGS. 10A-10C, a flowchart illustrating a process for abstracting objects captured in images by smart vehicles to balance vehicle functionality with confidentiality preservation is shown in accordance with an illustrative embodiment. The process shown in FIGS. 10A-10C may be implemented in a smart vehicle, such as, for example, smart vehicle 101 in FIG. 1 or smart vehicle 302 in FIG. 3. For example, the process shown in FIGS. 10A-10C may be implemented by smart vehicle object abstraction code 200 in FIG. 1.

The process begins when the smart vehicle, using an IoT sensor set, captures an image of an environment surrounding the smart vehicle along with contextual information regarding the environment (step 1002). The contextual information includes time of day, geographic location, vehicle speed, and vehicle direction of movement of the smart vehicle. In response to capturing the image, the smart vehicle, using computer vision and a set of machine learning models of an object detector, performs an analysis of the image of the environment surrounding the smart vehicle (step 1004).

The smart vehicle, using the computer vision and the set of machine learning models of an object detector, makes a determination as to whether the image of the environment surrounding the smart vehicle captures a set of objects based on the analysis of the image (step 1006). If the smart vehicle determines that the image of the environment surrounding the smart vehicle does not capture a set of objects based on the analysis of the image, no output of step 1006, then the process proceeds to step 1028. If the smart vehicle determines that the image of the environment surrounding the smart vehicle does capture a set of objects based on the analysis of the image, yes output of step 1006, then the smart vehicle, using a confidentiality filter, applies a set of confidentiality criteria to the set of objects captured in the image of the environment surrounding the smart vehicle (step 1008).

The smart vehicle, using the confidentiality filter, makes a determination as to whether one or more of the set of objects captured in the image of the environment surrounding the smart vehicle need to be abstracted based on applying the set of confidentiality criteria (step 1010). If the smart vehicle determines that the one or more of the set of objects captured in the image of the environment surrounding the smart vehicle do not need to be abstracted based on applying the set of confidentiality criteria, no output of step 1010, then the process proceeds to step 1028. If the smart vehicle determines that the one or more of the set of objects captured in the image of the environment surrounding the smart vehicle do need to be abstracted based on applying the set of confidentiality criteria, yes output of step 1010, then the smart vehicle, using an object relevant point identifier, identifies a plurality of relevant points on each of the one or more of the set of objects captured in the image of the environment surrounding the smart vehicle needing to be abstracted (step 1012).

Afterward, the smart vehicle, using an object relevant point extractor, extracts the plurality of relevant points corresponding to each of the one or more of the set of objects captured in the image of the environment surrounding the smart vehicle needing to be abstracted (step 1014). The smart vehicle, using an image generator, inserts the plurality of relevant points corresponding to each of the one or more of the set of objects into the image of the environment surrounding the smart vehicle forming an abstraction of each of the one or more of the set of objects needing to be abstracted (step 1016).

In addition, the smart vehicle, using the confidentiality filter, masks details in the image of the environment surrounding the smart vehicle except for the plurality of relevant points corresponding to each of the one or more of the set of objects inserted into the image to form an abstracted image of each of the one or more of the set of objects in the environment surrounding the smart vehicle to preserve confidentiality of the one or more of the set of objects while maintaining functionality of the smart vehicle (step 1018). Further, the smart vehicle attaches the contextual information regarding the environment as metadata to the abstracted image of each of the one or more of the set of objects in the environment surrounding the smart vehicle (step 1020).

The smart vehicle, using an image and metadata uploader, sends the abstracted image of each of the one or more of the set of objects in the environment surrounding the smart vehicle with the contextual information regarding the environment attached as the metadata to a set of data analysis services (step 1022). Subsequently, the smart vehicle, using a data analysis receiver, receives information regarding analysis of the abstracted image of each of the one or more of the set of objects in the environment surrounding the smart vehicle with the contextual information regarding the environment attached as the metadata from the set of data analysis services (step 1024). The information includes a prediction regarding movement of each of the one or more of the set of objects in the environment surrounding the smart vehicle in relation to the vehicle speed and the vehicle direction of movement of the smart vehicle.

The smart vehicle, using a smart vehicle operator, operates functional components of the smart vehicle automatically based on the information regarding the analysis of the abstracted image of each of the one or more of the set of objects in the environment surrounding the smart vehicle with the contextual information regarding the environment attached as the metadata received from the set of data analysis services (step 1026). The functional components of the smart vehicle include, for example, driving assistance, lane-keeping assistance, automatic braking, adaptive cruise control, parking assistance, and the like. Afterward, the smart vehicle makes a determination as to whether an input was received to turn off the smart vehicle (step 1028). If the smart vehicle determines that an input was not received to turn off the smart vehicle, no output of step 1028, then the process returns to step 1002 where the smart vehicle continues to capture images of the environment surrounding the smart vehicle using the IoT sensor set. If the smart vehicle determines that an input was received to turn off the smart vehicle, yes output of step 1028, then the process terminates thereafter.

Thus, illustrative embodiments of the present disclosure provide a method, smart vehicle system, and computer program product for abstracting objects captured in images by smart vehicles to balance vehicle functionality with confidentiality preservation. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
identifying a plurality of relevant points on each of one or more of a set of objects captured in an image of an environment needing to be abstracted;
inserting the plurality of relevant points corresponding to each of the one or more of the set of objects into the image of the environment forming an abstraction of each of the one or more of the set of objects needing to be abstracted; and
masking details in the image of the environment except for the plurality of relevant points corresponding to each of the one or more of the set of objects inserted into the image to form an abstracted image of each of the one or more of the set of objects in the environment to preserve confidentiality.

2. The method of claim 1, further comprising:
attaching contextual information regarding the environment as metadata to the abstracted image of each of the one or more of the set of objects in the environment; and
sending the abstracted image of each of the one or more of the set of objects in the environment with the contextual information regarding the environment attached as the metadata to a set of data analysis services.

3. The method of claim 2, further comprising:
receiving information regarding analysis of the abstracted image of each of the one or more of the set of objects in the environment surrounding a smart vehicle with the contextual information regarding the environment attached as the metadata from the set of data analysis services; and
operating functional components of the smart vehicle automatically based on the information regarding the analysis of the abstracted image of each of the one or more of the set of objects in the environment surrounding the smart vehicle with the contextual information regarding the environment attached as the metadata received from the set of data analysis services.

4. The method of claim 3, wherein the information includes a prediction regarding movement of each of the one or more of the set of objects in the environment surrounding the smart vehicle in relation to speed and direction of movement of the smart vehicle.

5. The method of claim 3, further comprising:
capturing the image of the environment surrounding the smart vehicle along with contextual information regarding the environment using an Internet of Things sensor set, the contextual information includes time of day, geographic location, vehicle speed, and vehicle direction of movement of the smart vehicle; and
performing an analysis of the image of the environment surrounding the smart vehicle using computer vision and a set of machine learning models.

6. The method of claim 1, further comprising:
determining whether the image of the environment captures the set of objects based on performing an analysis of the image; and
responsive to determining that the image of the environment does capture the set of objects based on the analysis of the image, applying a set of confidentiality criteria to the set of objects captured in the image of the environment.

7. The method of claim 1, further comprising:
determining whether the one or more of the set of objects captured in the image of the environment need to be abstracted based on applying a set of confidentiality criteria; and
responsive to determining that the one or more of the set of objects captured in the image of the environment do need to be abstracted based on applying the set of confidentiality criteria, identifying the plurality of relevant points on each of the one or more of the set of objects captured in the image of the environment needing to be abstracted.

8. A smart vehicle system comprising:
a processor set;
one or more computer-readable storage media; and
program instructions stored on the one or more computer-readable storage media to cause the processor set to perform operations comprising:
identifying a plurality of relevant points on each of one or more of a set of objects captured in an image of an environment needing to be abstracted;
inserting the plurality of relevant points corresponding to each of the one or more of the set of objects into the image of the environment forming an abstraction of each of the one or more of the set of objects needing to be abstracted; and
masking details in the image of the environment surrounding except for the plurality of relevant points corresponding to each of the one or more of the set of objects inserted into the image to form an abstracted image of each of the one or more of the set of objects in the environment to preserve confidentiality.

9. The smart vehicle system of claim 8, wherein the operations further comprise:
attaching contextual information regarding the environment as metadata to the abstracted image of each of the one or more of the set of objects in the environment; and
sending the abstracted image of each of the one or more of the set of objects in the environment with the contextual information regarding the environment attached as the metadata to a set of data analysis services.

10. The smart vehicle system of claim 9, wherein the operations further comprise:
receiving information regarding analysis of the abstracted image of each of the one or more of the set of objects in the environment surrounding a smart vehicle with the contextual information regarding the environment attached as the metadata from the set of data analysis services, wherein the information includes a prediction regarding movement of each of the one or more of the set of objects in the environment surrounding the smart vehicle in relation to speed and direction of movement of the smart vehicle; and
operating functional components of the smart vehicle automatically based on the information regarding the analysis of the abstracted image of each of the one or more of the set of objects in the environment surrounding the smart vehicle with the contextual information regarding the environment attached as the metadata received from the set of data analysis services.

11. The smart vehicle system of claim 10, wherein the operations further comprise:
capturing the image of the environment surrounding the smart vehicle along with contextual information regarding the environment using an Internet of Things sensor set, the contextual information includes time of day, geographic location, vehicle speed, and vehicle direction of movement of the smart vehicle; and
performing an analysis of the image of the environment surrounding the smart vehicle using computer vision and a set of machine learning models.

12. The smart vehicle system of claim 8, wherein the operations further comprise:
determining whether the image of the environment captures the set of objects based on performing an analysis of the image; and
responsive to determining that the image of the environment does capture the set of objects based on the analysis of the image, applying a set of confidentiality criteria to the set of objects captured in the image of the environment.

13. The smart vehicle system of claim 8, wherein the operations further comprise:
determining whether the one or more of the set of objects captured in the image of the environment need to be abstracted based on applying a set of confidentiality criteria; and
responsive to determining that the one or more of the set of objects captured in the image of the environment do need to be abstracted based on applying the set of confidentiality criteria, identifying the plurality of relevant points on each of the one or more of the set of objects captured in the image of the environment needing to be abstracted.

14. A computer program product comprising:
one or more computer-readable storage media; and
program instructions stored on the one or more computer-readable storage media to perform operations comprising:
identifying a plurality of relevant points on each of one or more of a set of objects captured in an image of an environment needing to be abstracted;
inserting the plurality of relevant points corresponding to each of the one or more of the set of objects into the image of the environment forming an abstraction of each of the one or more of the set of objects needing to be abstracted; and
masking details in the image of the environment except for the plurality of relevant points corresponding to each of the one or more of the set of objects inserted into the image to form an abstracted image of each of the one or more of the set of objects in the environment to preserve confidentiality.

15. The computer program product of claim 14, wherein the operations further comprise:
attaching contextual information regarding the environment as metadata to the abstracted image of each of the one or more of the set of objects in the environment; and
sending the abstracted image of each of the one or more of the set of objects in the environment with the contextual information regarding the environment attached as the metadata to a set of data analysis services.

16. The computer program product of claim 15, wherein the operations further comprise:
receiving information regarding analysis of the abstracted image of each of the one or more of the set of objects in the environment surrounding a smart vehicle with the contextual information regarding the environment attached as the metadata from the set of data analysis services; and
operating functional components of the smart vehicle automatically based on the information regarding the analysis of the abstracted image of each of the one or more of the set of objects in the environment surrounding the smart vehicle with the contextual information regarding the environment attached as the metadata received from the set of data analysis services.

17. The computer program product of claim 16, wherein the information includes a prediction regarding movement of each of the one or more of the set of objects in the environment surrounding the smart vehicle in relation to speed and direction of movement of the smart vehicle.

18. The computer program product of claim 16, wherein the operations further comprise:
capturing the image of the environment surrounding the smart vehicle along with contextual information regarding the environment using an Internet of Things sensor set, the contextual information includes time of day, geographic location, vehicle speed, and vehicle direction of movement of the smart vehicle; and
performing an analysis of the image of the environment surrounding the smart vehicle using computer vision and a set of machine learning models.

19. The computer program product of claim 14, wherein the operations further comprise:
determining whether the image of the environment captures the set of objects based on performing an analysis of the image; and
responsive to determining that the image of the environment does capture the set of objects based on the analysis of the image, applying a set of confidentiality criteria to the set of objects captured in the image of the environment.

20. The computer program product of claim 14, wherein the operations further comprise:
determining whether the one or more of the set of objects captured in the image of the environment need to be abstracted based on applying a set of confidentiality criteria; and
responsive to determining that the one or more of the set of objects captured in the image of the environment do need to be abstracted based on applying the set of confidentiality criteria, identifying the plurality of relevant points on each of the one or more of the set of objects captured in the image of the environment needing to be abstracted.
